(19) United States
(12) Patent Application Publication
(10) Pub. No.: US 2011/0187224 A1
(43) Pub. Date: Aug. 4, 2011

(54) Durable and Wearless Rotating Conductor Assembly Based on an Internal Magnetic Field for Transmitting Voltage and Current

(75) Inventor: Chong Kyu Kim, Fort Lee, NJ (US)

(73) Assignee: MATRIX MOTOR, LLC, Fort Lee, NJ (US)

(21) Appl. No.: 12/699,270

(22) Filed: Feb. 3, 2010

(51) Int. Cl. H01R 39/12

(52) U.S. Cl. 310/232

(57) ABSTRACT

This invention relates to a brushless slip ring using bearing for transmitting voltage and current between rotating rotor and stator. The invention relates to attaching a magnet to the slip ring to create a more stable rotor, eliminating sparks and erosions caused by the disconnection at times to the stator by enforcing a magnetic pull to the stator wall. In addition, a cooling-filtering system with synthetic oil can provide sufficient and constant clean lubrication.

### FIELD OF THE INVENTION

This invention relates to a slip ring usage for an electrically rotating machine, motor or generator. Current use of a carbon brush where the brush slides against the slip ring works relatively well on the slow rotating with a non-vibrating environment. However, substantial frictional wear and tear will occur at the high rotation, a vibrating environment and the combination of both.

### BACKGROUND OF THE INVENTION

U.S. Pat. No. 6,582,237 mainly deals with the electricity conduction between a pair of coaxial electrically conductive members with extra forces. This design can be used both in low and high speed rotation circumstances. However, it's either convenient or controllable if the force is not a magnetic one. U.S. Pat. No. 6,608,422 then chooses the spring forces to exert resistive forces into the first and second bearings, and thus support the entire structure. According to U.S. Pat. No. 2,409,600, journal bearings and tapper bearings are used for rotary element around the contact roller. This bearing has the ability to transmit both high voltage and current at a very low rpm. The downside of this setup is that when bearing missing contact occurs during the rotation, a spark results, which can oxidize the surface of the ring and eventually damage the bearing. This rolling element was improved on the U.S. Pat. No. 4,372,633 as an elastic flexible loop which improves the contact rolling capability. Unfortunately, the elastic flexible loop can create more wear on inner or outer surfaces, which will lead to high resistance and inconsistent electric transmission. U.S. Pat. No. 5,923,114 acknowledged these problems and tried to solve them by having tight couple spherical bearing with multi contacts. “A radial spacing between the surfaces is slightly smaller than a diameter of at least some of the rotary elements.” “All of the rotary elements are inserted into the space in the axial direction until each of the rotary elements is rolling contact with both of the inner and outer surfaces.” Of course more rolling elements will result in more contact but this does not totally remove the problem, with sparks occurring randomly when one of rolling elements missed contact due to a gap necessary to rotate the spherical element. In addition, U.S. Pat. No. 6,608,422 suggests a slip-plate assembly and method for conducting electricity, without solving the problem encountered in U.S. Pat. No. 5,923,114.

With high voltage and current rotary environment, U.S. Pat. No. 2,409,600 using bearing has more consistent spark due to missing contact than random spark via U.S. Pat. No. 5,923,114; sparks oxidize the slip ring wall at times and create dark carbons, which is detrimental to the slipping. U.S. Pat. No. 4,846,695 brings along the concept of magnetized stator, however it is only applied in bus bar connector while U.S. Pat. No. 5,454,724 puts forward an idea of using a magnetized ring in the spindling motor to achieve a controlled resistance electrical path from one element to the second one without any combination. Although U.S. Pat. No. 4,797,013 employs a ferrofluid method to make the high voltage and current transmission possible, its seal problem may affect the robustness of the device and thus hamper the real-world application.

The aforementioned patents can be improved in two major ways. The primary way is by placing a magnetic field over the cylindrical bearing type (journal or tapper bearing), so that the ring (cylindrical rolling element) is in constant contact with the outer wall via magnetic pull between the metal. The second use of the magnet is noise reduction as the electricity is transmitted through wires. Synthetic oil is a choice lubricant rather than thick oil for the bearing. The rolling element size will be proportionally larger for high voltage or current. Also, magnet strength is controlled via thickness of magnet.

Due to the present of a magnetic field, a constant torque has to be overcome in order for the rotary element to rotate. This nominal torque is obtained using a thin plastic layer to increase distance between actual magnet and the ring. This can result in immediate weakness to the magnetic pull due to the inverse square nature of the magnet. The direct contact is optional when enough energy input is available so that the small braking effect created by the magnet is negligible.

Thick oil is used for bearing in order to smooth rolling elements. Thick oil can result in a gap between the rolling element and the ring. This can produce sparks, which can result in engulfing of carbonation. This will lead to more friction and failure to the bearing. Synthetic oil can improve this condition by having uniform molecules in the oil itself. Using the rolling element horizontally, two plastic caps can be placed to prevent the synthetic oil from flowing out. However, if this same element stands vertically, all the synthetic oil will flow out, which is a main disadvantage. Note that for vertical situation, an extra capsule has to be made so that the synthetic oil won't flow out.

### SUMMARY OF THE INVENTION

The present invention relates to using bearing for transmitting both low and high voltage and current between the rotating rotor and stator for use in a dynamically operating electric machine, e.g. a device that includes a motor, generator, a transmission system and automatic mechanisms. A spherical bearing is usually considered to be an ideal apparatus for some low-power applications. The present invention relates to inserting a magnet to create the rotor to be more stable to the stator by magnetic pull to the stator wall with a non-spherical bearing. There are three main ways to make the transmitting voltage and current without sparks possible, and are listed as follows.

(I) Rotor with a Magnetized Stationary Housing

Make the stationary housing magnetized through a electromagnet to apply a permanent magnetic force on it. In this case, the stationary housing will attach to the rotor but not strongly enough to brake the rotor itself. This method can be employed in a relatively low rotation speed scenario.

(II) Rotor and Stator Together with Two Additional Metal Rings

If used in a high rotational speed circumstances, the device should be modified. The centrifugal force will be much higher and thus a stronger magnetic force should be applied. However, it is more practical to put a non-magnetic metal between the magnet and the objective metal rather than controlling the magnetic force. Thus, two additional metal rings should be attached to the ordinary rotor and stator, i.e. a brass metal piece is put next to the stationary housing with a magnetic ring behind it.

(III) Rotor and Stator with Magnet Wires Wrapped

As the rotational speed of rotor increases, the magnetic force introduced by magnet is not sufficient. In this case, electric wires are wrapped over the stationary housing. By applying a DC power source at first, a much stronger magnetic force to tie the rotor and stator together will be created.

Hence, the design that we use can cover both low and high voltage cases that not only make the voltage and current successful and safe transmission in high voltage possible, but broaden the coverage of the design.

The present invention also relates to a method of a new cooling-filtering system with synthetic oil. Because of the higher purity of synthetic oil, the properties of synthetic oil can stand up to heat much better before breaking down than conventional oil. Likewise, synthetic oil can also withstand colder temperatures better than conventional oil. In addition, the performance additives used in synthetic oils are engineered with special additives that help to fight off sludge and mineral deposits that are naturally caused in heating/combustion. Therefore, a quality of lubrication and cooling can be reached and thus extend the longevity of the device.

### BRIEF DESCRIPTION OF THE DRAWING

The objects and advantages of the invention will become apparent from the following detailed description of preferred embodiments thereof in connection with the accompanying drawings in which like numerals designate like elements and in which:

FIG. 1 is an exploded perspective view of a brushless slip ring according to the present invention;

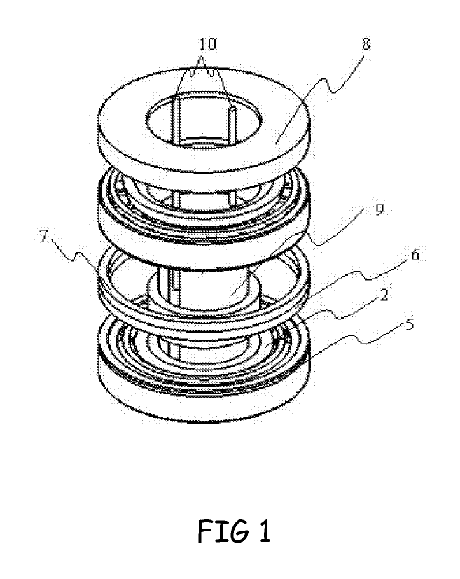

FIG. 2 is a longitudinal sectional view of the slip ring assembly depicted in FIG. 1.

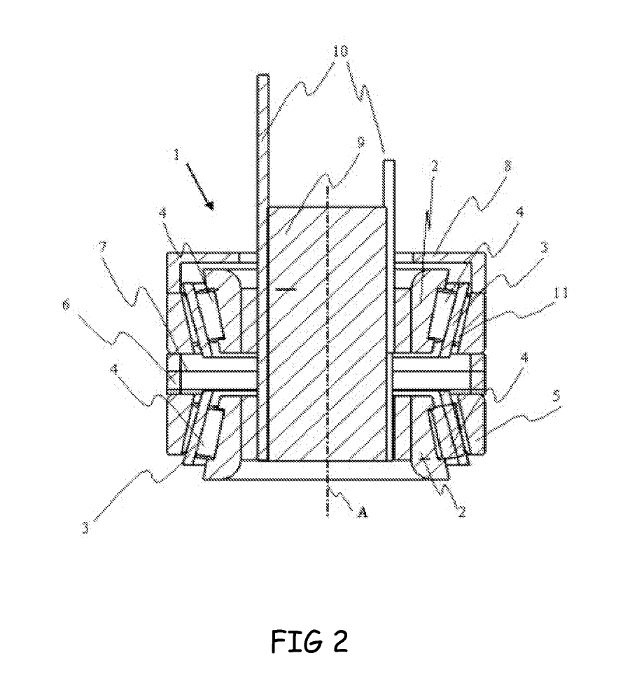

FIG. 3 is a schematic end view of the slip ring according to the invention.

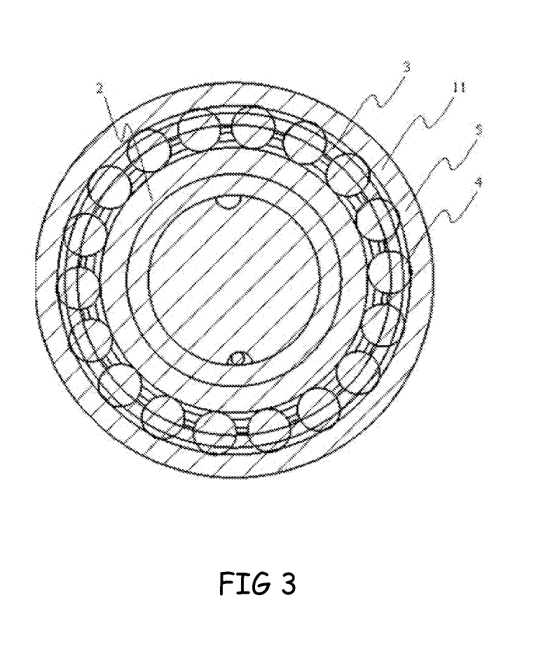

FIG. 4 is a schematic end view of the metal rings according to the invention.

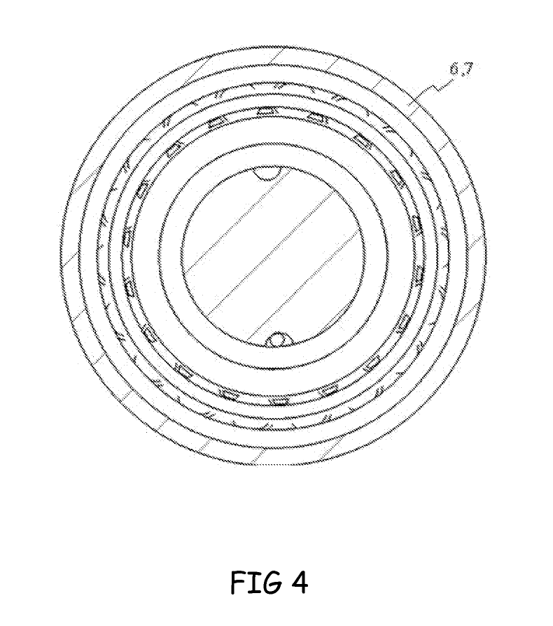

FIG. 5 is a schematic end view of the magnetic metal ring in FIG. 4.

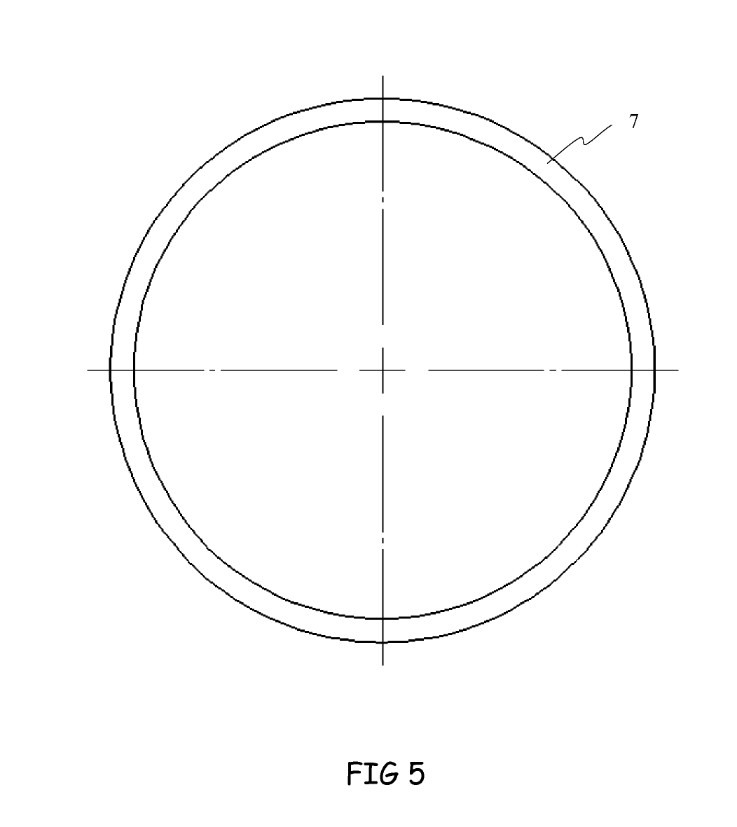

FIG. 6 is a schematic end view of the metal ring attached to the magnetic metal piece in FIG. 4.

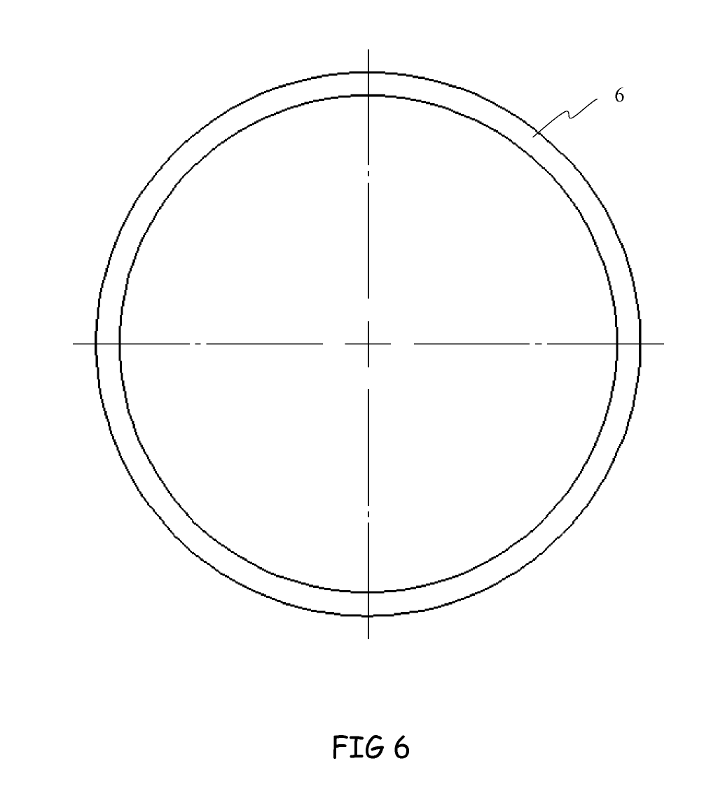

FIG. 7 is a schematic end view of the supporter ring.

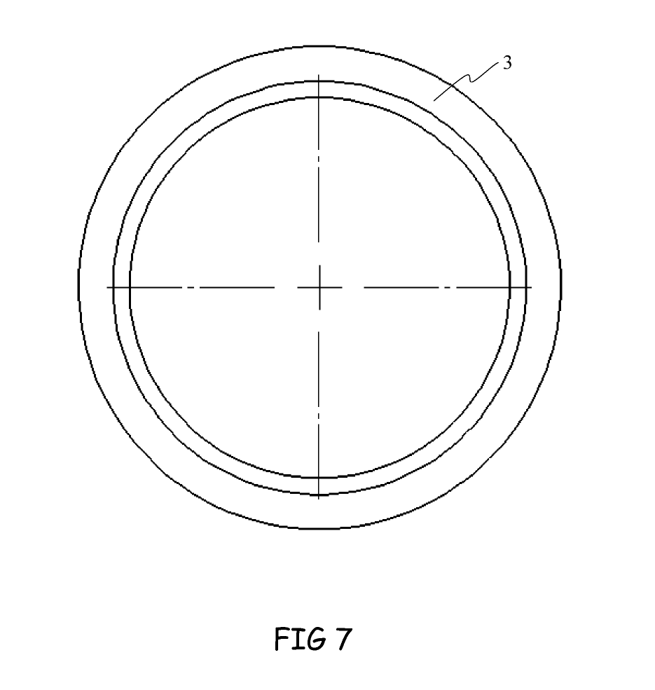

FIG. 8 is a schematic front and end view of the rotor ring.

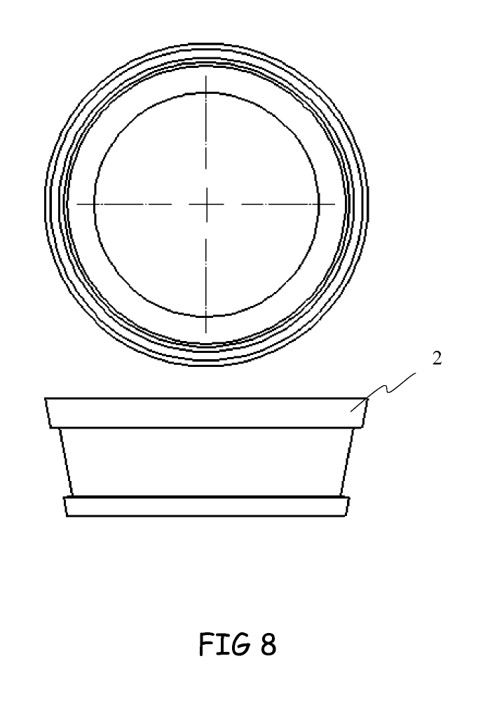

FIG. 9 is a schematic end and left view of the non-conductive shaft.

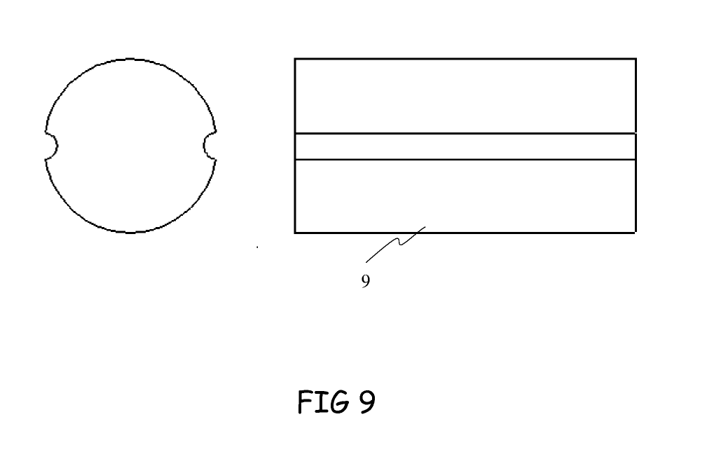

FIG. 10 is a schematic front and end view of the bearing wheel.

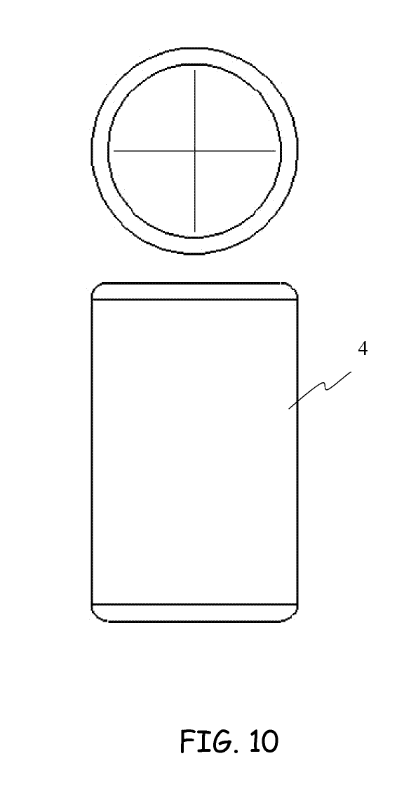

FIG. 11 is a schematic ISO (oblique) view of the conductive wire.

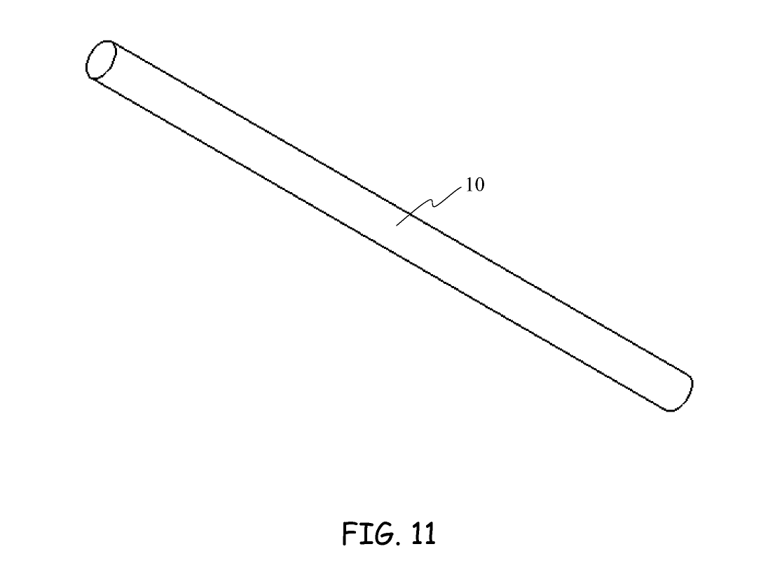

FIG. 12 is a schematic top and end view of the bearing plastic cap.

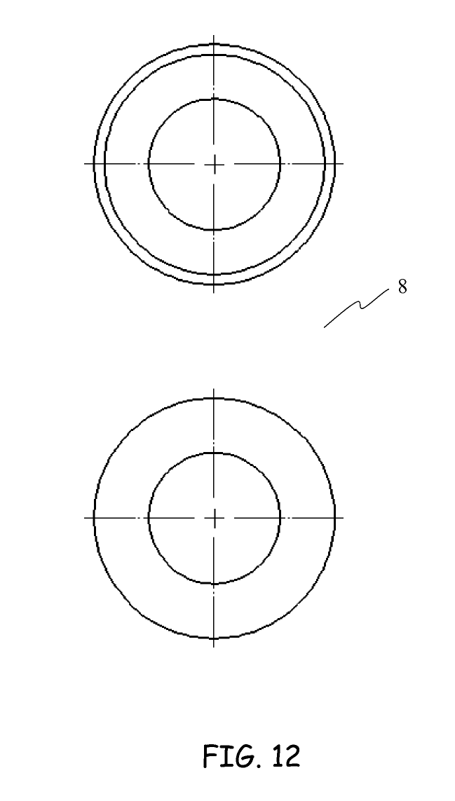

### DETAILED DESCRIPTION OF PREFERRED EMBODIMENTS OF THE INVENTION

The invention relates to brushless slip rings, preferably for use in transmitting both low and high voltage and current without spark through a rotating interface with good lubrication.

The brushless slip ring 1 comprises stacks of ring elements arranged coaxially with respect to an axis A, which axis could be vertical or horizontal.

Each stack includes a rotor ring 2, a supporter ring 3, large number of movable balls 4, a radically outwardly spaced stator ring 5. The rotor ring 2 and stator ring 5 are coplanar and made up of an electrically conductive material, such as copper, which may be placed by precious metal, preferably silver. Rolling elements in the form of equal diameter movable spherical (or cylinders) balls 4 are put in an annular space 11. The balls are preferably formed of an electrically conductive material such as brass, copper, which may be placed by precious metal, preferably silver. The materials that selected for the balls 4 are preferably harder than that chosen for rings 2, 3 and 5. The balls should be rigid enough so that balls will not deform under the forces imposed thereon in the bushing.

The balls 4 and rings 2, 3 and 5 are designed to ensure that the balls will fit into the spaces 11 and yet be disposed so closely to the rings that an electrical path will always be established between the rings and balls.

Metal ring 6 is designed to absorb some of the magnetized forces applied by magnetized metal ring 7 in order not to make the rotor brake because of the strong magnetic force. Ring 6 and 7 have the same diameters and axes as ring 2, 3 and 5. Ring 6 is usually made up of non-magnetized metal, such as brass or copper while ring 7 should be formed of a magnetized metal. As pointed out earlier herein, ring 6 and 7 are not compulsory parts in some cases, i.e. low rotation speed and extremely high rotation speed; they are only designed for a relatively high rotation speed or medium voltage situations.

An electrical non-conductive cover 8 is put at the end of stationary ring 4 to make the whole bearing fixed on the shaft 9. Electric wires 10 are put within the shaft 9 to conduct the electric current.

One embodiment is a brushless slip ring used in low voltage and current situation. The stationary ring 5 is magnetized by electromagnet to apply a permanent magnetic force on it. Thus, the magnetic force will pull the rotor ring 2 tightly to the movable balls and push the balls to the ring 5. In this case, there will be no disconnection between ring 2 and 5, eliminating the sparks. The magnitude of the magnetic force is controlled by the degree of magnetization of ring 5. Note that ring 6 and 7 are no longer needed in this case. Synthetic oil is used in this embodiment to enhance the lubrication, cooling and filtering off the impurities.

Another embodiment is that ring 6 and 7 are put in and ring 5 is without magnetized. The magnitude of magnetic force is controlled by the thickness of ring 6. Thus, the magnetic force will pull the rotor ring 2 tightly to the movable balls and push the balls to the ring 5. In this case, there will be no disconnection between ring 2 and 5, eliminating the sparks. The stronger force is needed, the thinner thickness of ring 6 should be. Such kind of assembly is suitable for medium or high voltage and current transmission. Synthetic oil is used in this embodiment to enhance the lubrication, cooling and filtering off the impurities.

Another embodiment is that electric wires are wrapped around ring 5. When there is electric current applied on the electric wire, a magnetic field will be introduced, making the ring 5 magnetized. Thus, the magnetic force will pull the rotor ring 2 tightly to the movable balls and push the balls to the ring 5. In this case, there will be no disconnection between ring 2 and 5, eliminating the sparks. The magnitude of the magnetic force is dependent upon the magnetic of electric field applied on the wrapped wires. Note that ring 6 and 7 are no longer needed in this case. Such kind of assembly is suitable for high or extremely high voltage and current transmission. Synthetic oil is used in this embodiment to enhance the lubrication, cooling and filtering off the impurities.

The cooling-filtering system mainly refers to the lubricant, synthetic oil. Synthetic oil is filled up and stored in the retainer rings 3. With the relative rotation between rotor and stator, synthetic oil forms a thin oil layer among them, ameliorating the contact friction condition and significantly extending the longevity of the device. Meanwhile, due to ultra-strong cooling and filtering ability of synthetic oil, the whole system keeps a clean and relatively low-temperature condition. The usage of synthetic oil in combination with the brushless slip ring provides a promising, durable and wearless wide-range electricity transmission assembly.

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

What is claimed is:

1. A brushless slip ring apparatus for use in a dynamically operating electric machine, comprising:
a housing;
inner and outer members mounted in the housing for relative rotation about a longitudinal axis, said inner and outer members including radially spaced inner and outer electrically conductive surfaces forming an annular space between, said rings being rotated driven by the power source; and
a cage-less assembly of electrically conductive rolling elements disposed radially rotatable in said space for conducting electricity between said outer and inter surfaces, said rolling elements being rigid and with connection to both rotor rings, supporter rings, movable balls and stationary rings during the operation of machine.

2. The brushless slip ring apparatus according to claim 1, further including two pieces of ring metal coaxially attached next to the stationary ring, with one of them magnetized and the other metal non-magnetized, the thicknesses of the two individual sheets being determined by the magnetic force needed according to the application objectives.

3. The brushless slip ring apparatus according to claim 1, further including a magnetized stationary or rotor ring.

4. The brushless slip ring apparatus according to claim 1, further including a stationary ring with wrapped electric wires over it.

5. The brushless slip ring apparatus according to claim 1 wherein said rolling elements are of spherical, cylindrical, tapered-cylindrical or any other rolling shapes.

6. The brushless slip ring apparatus according to claim 1, further including a stationary ring magnetized either from a permanent magnet or an electromagnet.

7. The brushless slip ring apparatus according to claim 1 wherein the annular row means comprises one annular row of rolling elements.

8. The brushless slip ring apparatus according to claim 1 wherein said retainer rings holding synthetic oil to make the cooling and lubrication more effective thus expand the longevity of the brushless slip ring.
